(19) United States
(12) Patent Application Publication
(10) Pub. No.: US 2026/0029057 A1
(43) Pub. Date: Jan. 29, 2026

(54) SERIES-PARALLEL FLUID SWITCHING STRUCTURE, FLUID PUMP, AND POOL CLEANER

(71) Applicant: NINGBO JUNHE INTELLIGENT TECHNOLOGY CO., LTD., Ningbo (CN)

(72) Inventors: Junbo ZHANG, Ningbo (CN); Ke YANG, Ningbo (CN)

(73) Assignee: NINGBO JUNHE INTELLIGENT TECHNOLOGY CO., LTD., Ningbo (CN)

(21) Appl. No.: 19/276,047

(22) Filed: Jul. 22, 2025

(30) Foreign Application Priority Data
Jul. 24, 2024 (CN) 202411001320.9
Jun. 6, 2025 (CN) 202510756315.7

(51) Int. Cl. F16K 11/044; E04H 4/16

(52) U.S. Cl. CPC F16K 11/044; E04H 4/1636

(57) ABSTRACT

A series-parallel fluid switching structure, a fluid pump, and a pool cleaner are provided. The series-parallel fluid switching structure includes a first cavity, a second cavity, and a switching mechanism, where the first cavity is provided with a first water inlet, and the second cavity is provided with a second water inlet; a first passage is disposed between the first cavity and the second cavity; the first passage includes an inlet communicating with the first cavity and an outlet communicating with the second cavity; the first passage is provided with a first water outlet communicating with an external environment; the second cavity is provided with a second water outlet; the switching mechanism is configured to control opening/closing of the first water outlet, opening/closing of the outlet of the first passage, and opening/closing of the second water inlet.

### CROSS-REFERENCE TO THE RELATED APPLICATIONS

This application is based upon and claims priority to Chinese Patent Application No. 202411001320.9, filed on Jul. 24, 2024; and Chinese Patent Application No. 202510756315.7, filed on Jun. 6, 2025, the entire contents of which are incorporated herein by reference.

### TECHNICAL FIELD

The present disclosure relates to the technical field of fluid delivery and in particular to a series-parallel fluid switching structure, a fluid pump, and a pool cleaner.

### BACKGROUND

In the prior art, Chinese patent application CN112879308A discloses a multi-stage centrifugal pump, including a pump body, a rotating shaft, a first impeller, a second impeller, a third impeller, and a switching mechanism. The rotating shaft is rotatably connected inside the pump body, and is fixedly connected to the first impeller, the second impeller, and the third impeller in sequence from left to right. A first suction inlet is formed between the left side of the first impeller and the pump body, and a first water outlet is formed between the right side of the first impeller and the pump body. A second suction inlet is formed between the left side of the second impeller and the pump body, and a second water outlet is formed between the right side of the second impeller and the pump body. A third suction inlet is formed between the left side of the third impeller and the pump body, and a third water outlet is formed between the right side of the third impeller and the pump body. The pump body includes a left side provided with an inlet A communicating with the first suction inlet and a right side provided with an outlet B. However, the multi-stage centrifugal pump can only change the number of series stages to change the head, making it unsuitable for high-flow-rate working conditions.

### SUMMARY

An objective of the present disclosure is to provide a series-parallel fluid switching structure, a fluid pump, and a pool cleaner, which are applicable to multiple modes.

The present disclosure adopts the following technical solutions. A series-parallel fluid switching structure includes a first cavity, a second cavity, and a switching mechanism, where the first cavity is provided with a first water inlet, and the second cavity is provided with a second water inlet; a first passage is disposed between the first cavity and the second cavity; the first passage includes an inlet communicating with the first cavity and an outlet communicating with the second cavity; the first passage is provided with a first water outlet communicating with an external environment; the second cavity is provided with a second water outlet; the switching mechanism is located between the first cavity and the second cavity, and is configured to control opening/closing of the first water outlet, opening/closing of the outlet of the first passage, and opening/closing of the second water inlet; in a parallel state, the first water outlet is open, the outlet of the first passage is closed, and the second water inlet is open; a fluid in the first cavity flows out from the first water outlet, and fluid in the second cavity flows out from the second water outlet; in a series state, the first water outlet is closed, the outlet of the first passage is open, and the second water inlet is closed; and the fluid in the first cavity flows out sequentially through the outlet of the first passage, the second cavity, and the second water outlet.

Compared with the prior art, the present disclosure has the following advantages. The switching mechanism enables series-parallel switching between the first cavity and the second cavity to achieve different working modes. In the parallel state, the external fluid enters the first cavity through the first water inlet and flows out from the first water outlet of the first passage. Meanwhile, the external fluid enters the second cavity through the second water inlet and flows out from the second water outlet, achieving high-flow-rate operation. In the series state, the external fluid enters the first cavity through the first water inlet, enters the second cavity from the outlet of the first passage, and flows out from the second water outlet, achieving high-head operation.

In some embodiments of the present disclosure, the switching mechanism is a valve member; the valve member is provided with a through second passage and through third passages; in the parallel state, the first water outlet communicates with the second passage, the outlet of the first passage is blocked by the valve member, and the second water inlet communicates with the third passage; and in the series state, the first water outlet is blocked by the valve member, the outlet of the first passage communicates with the third passage, and the second water inlet is blocked by the valve member.

Furthermore, the valve member is annular, and rotatable relative to the second cavity; the first water outlet is disposed on a rotation path of the second passage; the second water inlet and the outlet of the first passage are disposed on a rotation path of the third passage; and the second water inlet and the outlet of the first passage are arranged adjacent to each other in a radial direction.

In some embodiments of the present disclosure, the series-parallel fluid switching structure further includes a first housing, where the first cavity is disposed in the first housing; a portion of the second cavity is disposed on the first housing; the first cavity is located below the second cavity; the first water inlet is disposed at a lower surface of the first housing; the first passage is disposed in the first housing; the outlet of the first passage is located above the inlet of the first passage; the first water outlet is disposed at an upper surface of the first housing; and the second water inlet is disposed at a side surface of the first housing.

Furthermore, the series-parallel fluid switching structure further includes a second housing, where the second housing is connected to the first housing; the second cavity is disposed between the first housing and the second housing; and the second water outlet is disposed at a side surface of the second housing.

In some embodiments of the present disclosure, the first cavity is internally provided with a first impeller; the first impeller includes a water inlet communicating with the first water inlet and a water outlet communicating with the first cavity; the second cavity is internally provided with a second impeller; and the second impeller includes a water inlet communicating with the second water inlet and a water outlet communicating with the second cavity.

Furthermore, the second cavity includes an upper cavity and a lower cavity; the second impeller is located in the upper cavity; the water inlet of the second impeller communicates with the lower cavity; the second water inlet and the outlet of the first passage are located in the lower cavity; and the second water outlet is located in the upper cavity.

In some embodiments of the present disclosure, the first cavity and the second cavity are coaxial.

Furthermore, the first passage includes a horizontal passage and a rising passage; the horizontal passage includes one end communicating with the first cavity and the other end communicating with one end of the rising passage; the other end of the rising passage communicates with the second cavity; a curved surface is provided between the horizontal passage and the rising passage; the first water outlet is located in the rising passage; and two sides of the horizontal passage in a horizontal direction are curved.

Furthermore, the valve member is provided with an outwardly protruding toggle member; and the toggle member is configured to drive rotation of the valve member.

Furthermore, there are at least two third passages; an oblique blocking plate is provided between adjacent third passages; the blocking plate is configured to block the outlet of the first passage or the second water inlet; and a shape of the outlet of the first passage and a shape of the second water inlet match the blocking plate.

Furthermore, the first housing is provided with a first pressure-differential notch and/or a second pressure-differential notch; the first pressure-differential notch is located at the outlet of the first passage; a first pressure-differential engagement zone is formed between the first pressure-differential notch and the switching mechanism; the second pressure-differential notch is located at an outer edge of a top surface of the first housing; and a second pressure-differential engagement zone is formed between the second pressure-differential notch and the switching mechanism.

A fluid pump includes the above-mentioned series-parallel fluid switching structure and a first outer housing, where the first cavity and the second cavity are located in the first outer housing; the first outer housing is provided with a third water outlet and a third water inlet; the third water outlet communicates with the first water outlet and the second water outlet; and the third water inlet communicates with the first water inlet and the second water inlet.

Furthermore, the first outer housing includes a base and an upper cover; the base and the upper cover are detachably connected; the third water inlet is located on the base; and the third water outlet is located on the upper cover.

A pool cleaner includes the above-mentioned series-parallel fluid switching structure and a second outer housing, where the first cavity and the second cavity are located in the second outer housing; the second outer housing is provided with a fourth water outlet and a fourth water inlet; the fourth water outlet communicates with the first water outlet and the second water outlet; and the fourth water inlet communicates with the first water inlet and the second water inlet.

### BRIEF DESCRIPTION OF THE DRAWINGS

FIG. 1 is a first structural schematic diagram according to Embodiment 1 of the present disclosure;

FIG. 2 is a second structural schematic diagram according to Embodiment 1 of the present disclosure;

FIG. 3 is a sectional view of according to Embodiment 1 of the present disclosure;

FIG. 4 is an exploded view according to Embodiment 1 of the present disclosure;

FIG. 5 is a structural schematic diagram of a valve member according to Embodiment 1 of the present disclosure;

FIG. 6 is a structural schematic diagram of a first housing according to Embodiment 1 of the present disclosure;

FIG. 7 is a top view of the first housing according to Embodiment 1 of the present disclosure;

FIG. 8 is a sectional view taken along A-A direction shown in FIG. 7;

FIG. 9 is a structural schematic diagram according to Embodiment 2 of the present disclosure;

FIG. 10 is a sectional view according to Embodiment 2 of the present disclosure;

FIG. 11 is a structural schematic diagram according to Embodiment 3 of the present disclosure;

FIG. 12 is a sectional view according to Embodiment 3 of the present disclosure;

FIG. 13 is a detail of B shown in FIG. 12;

FIG. 14 is a structural schematic diagram according to Embodiment 4 of the present disclosure;

FIG. 15 is a structural schematic diagram of a valve member according to Embodiment 4 of the present disclosure;

FIG. 16 is a structural schematic diagram of a first housing according to Embodiment 4 of the present disclosure;

FIG. 17 is a structural schematic diagram according to Embodiment 5 of the present disclosure; and

FIG. 18 is a sectional view according to Embodiment 5 of the present disclosure.

Reference Numerals: 1. first cavity; 101. first water inlet; 2. second cavity; 201. second water inlet; 202. second water outlet; 203. upper cavity; 204. lower cavity; 3. first passage; 301. first water outlet; 302. horizontal passage; 303. rising passage; 304. curved surface; 4. valve member; 401. second passage; 402. third passage; 403. toggle member; 404. blocking plate; 5. first housing; 501. first notch; 502. first pressure-differential notch; 503. second pressure-differential notch; 6. second housing; 701. first impeller; 702. second impeller; 8. first outer housing; 801. third water outlet; 802. third water inlet; 803. base; 804. upper cover; 805. second notch; 9. wear-resistant assembly; 901. first wear-resistant part; 902. second wear-resistant part; 10. motor; 11. second outer housing; 12. fourth water outlet; 13. fourth water inlet; and 14. third notch.

### DETAILED DESCRIPTION OF THE EMBODIMENTS

To further describe the technical means adopted by the present disclosure to achieve the intended purpose and the effects of the technical means, the specific implementations, structures, features, and effects of the present disclosure are described in detail below with reference to the drawings and preferred embodiments.

### Embodiment 1

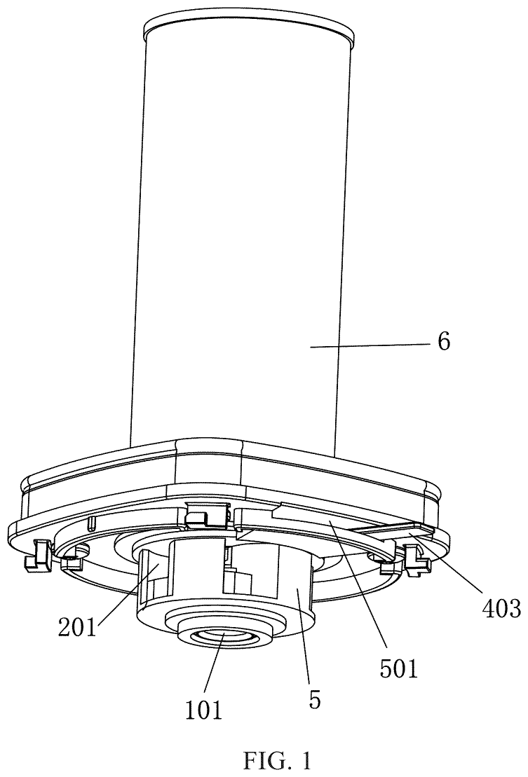

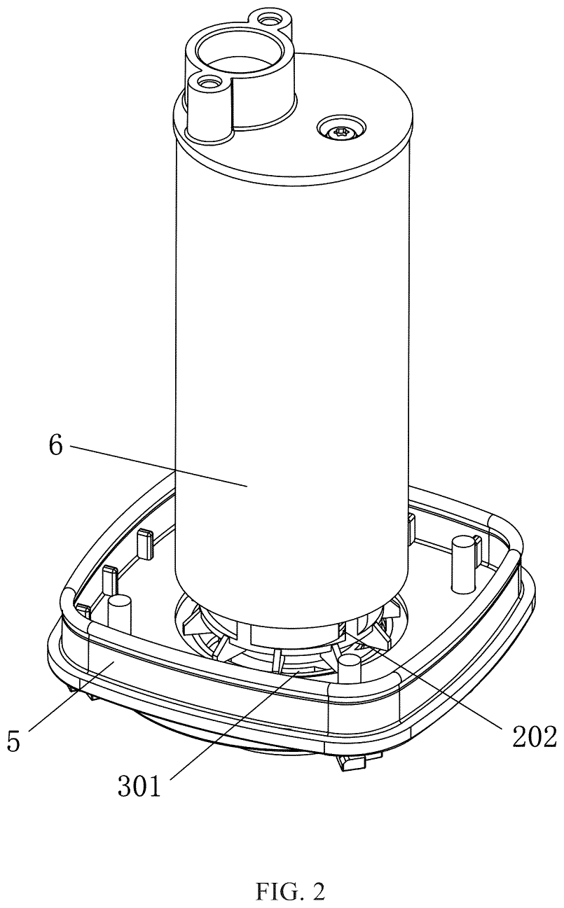

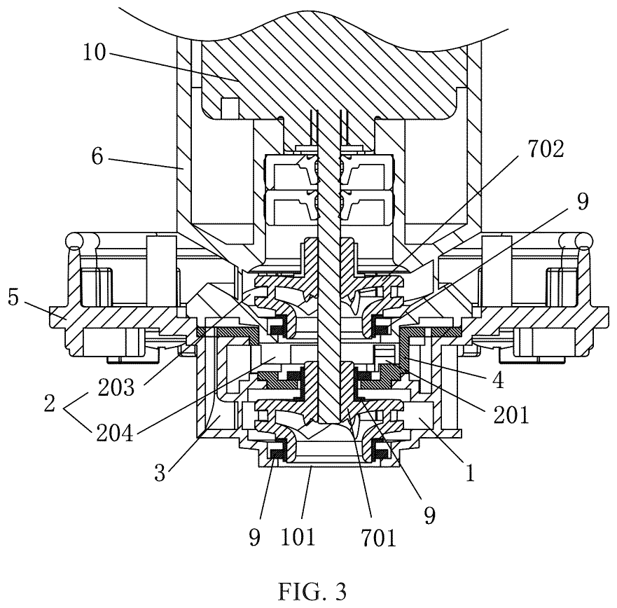

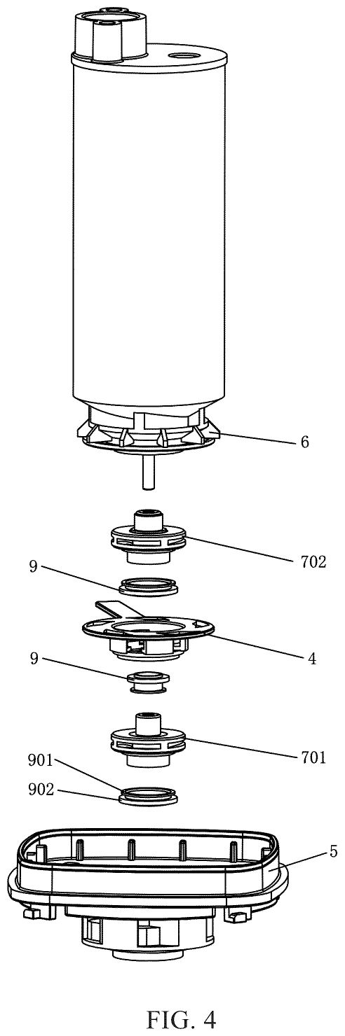

This embodiment provides a series-parallel fluid switching structure. As shown in FIGS. 1 to 4, the series-parallel fluid switching structure includes first cavity 1, second cavity 2, and a switching mechanism. The first cavity 1 is provided with first water inlet 101, and the second cavity 2 is provided with second water inlets 201. First passages 3 are disposed between the first cavity 1 and the second cavity 2. The first passage 3 includes an inlet communicating with the first cavity 1 and an outlet communicating with the second cavity 2. The first passage 3 is provided with first water outlet 301 communicating with an external environment. The second cavity 2 is provided with second water outlet 202. The switching mechanism is located between the first cavity 1 and the second cavity 2, and is configured to control opening/closing of the first water outlet 301, opening/closing of the outlet of the first passage 3, and opening/closing of the second water inlet 201. In a parallel state, the first water outlet 301 is open, the outlet of the first passage 3 is closed, and the second water inlet 201 is open. A fluid in the first cavity 1 enters from the first water inlet 101 and flows out from the first water outlet 301. A fluid in the second cavity 2 enters from the second water inlet 201 and flows out from the second water outlet 202. In a series state, the first water outlet 301 is closed, the outlet of the first passage 3 is open, and the second water inlet 201 is closed. The fluid in the first cavity 1 flows out sequentially through the outlet of the first passage 3, the second cavity 2, and the second water outlet 202. That is, the fluid in the first cavity 1 enters from the first water inlet 101 and flows out through the first passage 3. The fluid in the second cavity 2 enters from the first passage 3 and flows out through the second water outlet 202. In this embodiment, the first cavity 1 and the second cavity 2 are pump cavities. Of course, more cavities may be added to achieve more stages of series-parallel connection.

The switching mechanism enables series-parallel switching between the first cavity 1 and the second cavity 2 to achieve different working modes. In the parallel state, the external fluid enters the first cavity 1 through the first water inlet 101 and flows out from the first water outlet 301 of the first passage 3. Meanwhile, the external fluid enters the second cavity 2 through the second water inlet 201 and flows out from the second water outlet 202, achieving high-flow-rate operation. In the series state, the external fluid enters the first cavity 1 through the first water inlet 101, enters the second cavity 2 from the outlet of the first passage 3, and flows out from the second water outlet 202, achieving high-head operation.

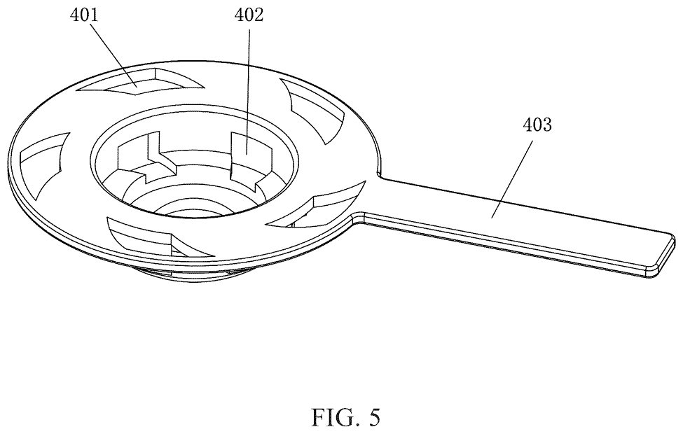

For reliable switching, as shown in FIG. 5, the switching mechanism is valve member 4. The valve member 4 is provided with through second passage 401 and through third passages 402. In the parallel state, the first water outlet 301 communicates with the second passage 401, the outlet of the first passage 3 is blocked by the valve member 4, and the second water inlet 201 communicates with the third passage 402. In the series state, the first water outlet 301 is blocked by the valve member 4, the outlet of the first passage 3 communicates with the third passage 402, and the second water inlet 201 is blocked by the valve member 4. The second passage 401 is configured to open the first water outlet 301. When the second passage 401 communicates with the first water outlet 301, the first water outlet 301 is open. When the first water outlet 301 is blocked by the valve member 4, it is closed. The third passage 402 is configured to switch opening of the outlet of the first passage 3 and the second water inlet 201. That is, when the third passage 402 communicates with the outlet of the first passage 3, the second water inlet 201 is blocked by the valve member 4 and closed. When the third passage 402 communicates with the second water inlet 201, the outlet of the first passage 3 is blocked by the valve member 4 and closed.

For reliable switching, the valve member 4 is annular. The valve member 4 is rotatable relative to the second cavity 2. The first water outlet 301 is disposed on a rotation path of the second passage 401. The second water inlet 201 and the outlet of the first passage 3 are disposed on a rotation path of the third passage 402. The second water inlet 201 and the outlet of the first passage 3 are arranged adjacent to each other in a radial direction. In this embodiment, there are five second water inlets 201, five first water outlets 301, five first passages 3, five second water outlets 202, and one first water inlet 101. The second water outlets 202, the second water inlets 201, the first water outlets 301, and the outlets of the first passages 3 are uniformly distributed around a center of the second cavity 2. The rotating valve member 4 achieves switching between series and parallel modes, making the switching operation simple and convenient. When the valve member 4 rotates, the second passage 401 and the third passage 402 rotate synchronously, causing the second passage 401 to communicate with the first water outlet 301 and the third passage 402 to communicate with the outlet of the first passage 3 or the second water inlet 201. The second water inlet 201 and the outlet of the first passage 3 are arranged adjacent to each other, allowing the third passage 402 to communicate with only one of them.

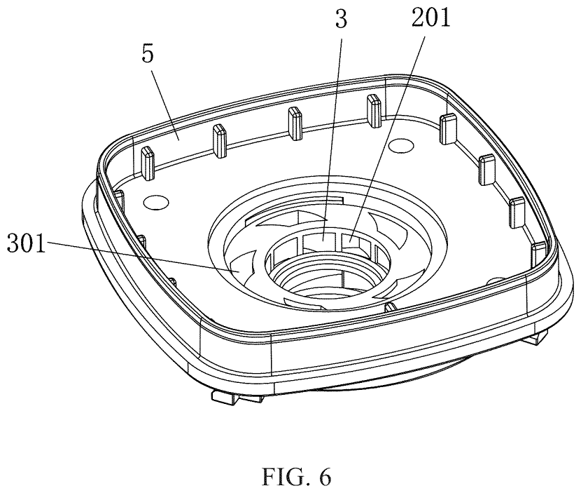

To ensure structural reliability, as shown in FIG. 6, the series-parallel fluid switching structure further includes first housing 5. The first cavity 1 is disposed in the first housing 5. A portion of the second cavity 2 is disposed on the first housing 5. The first cavity 1 is located below the second cavity 2. The first water inlet 101 is disposed at a lower surface of the first housing 5. The first passage 3 is disposed in the first housing 5. The outlet of the first passage 3 is located above the inlet of the first passage 3. The first water outlet 301 is disposed at an upper surface of the first housing 5. The second water inlet 201 is disposed at a side surface of the first housing 5.

To ensure structural reliability, the series-parallel fluid switching structure further includes second housing 6. The second housing 6 is connected to the first housing 5. The second cavity 2 is disposed between the first housing 5 and the second housing 6. The second water outlet 202 is disposed at a side surface of the second housing 6. The valve member 4 is disposed between the first housing 5 and the second housing 6, and rotatably connected to the first housing 5.

To ensure reliable fluid entry, the first cavity 1 is internally provided with first impeller 701. The first impeller 701 includes a water inlet communicating with the first water inlet 101 and a water outlet communicating with the first cavity 1. The second cavity 2 is internally provided with second impeller 702. The second impeller 702 includes a water inlet communicating with the second water inlet 201 and a water outlet communicating with the second cavity 2. The first impeller 701 and the second impeller 702 are driven by motor 10. The design of the first impeller 701 improves fluid delivery capacity. Through this design, during parallel operation, the second impeller 702 and the first impeller 701 simultaneously deliver the fluid to achieve a high flow rate. During series operation, the first impeller 701 and the second impeller 702 are arranged in two stages to increase head.

The inlet of the first passage 3 and the water outlet of the first impeller 701 are located on a same horizontal plane, facilitating fluid transfer from the first impeller 701 into the first passage 3. The second water outlet 202 and the water outlet of the second impeller 702 are located on a same horizontal plane, facilitating fluid transfer from the second impeller 702 into the second water outlet 202.

The first impeller 701 and the second impeller 702 are provided with wear-resistant assemblies 9, respectively. The wear-resistant assemblies 9 are configured to reduce frictional wear caused by the rotation of the first impeller 701 and the second impeller 702 to the first housing 5, the second housing 6, and the valve member 4, extending service life. The wear-resistant assemblies 9 are disposed between the first impeller 701 and the first housing 5, between the first impeller 701 and the valve member 4, and between the second impeller 702 and the second housing 6. The wear-resistant assembly 9 includes first wear-resistant part 901 and second wear-resistant part 902. The first wear-resistant part 901 is connected to the first impeller 701 or the second impeller 702. The second wear-resistant part 902 is connected to the first housing 5 or the second housing 6 or the valve member 4. The first wear-resistant part 901 and the second wear-resistant part 902 are rotatably connected.

To ensure reliability of the second cavity 2, the second cavity 2 includes upper cavity 203 and lower cavity 204. The second impeller 702 is located in the upper cavity 203. The water inlet of the second impeller 702 communicates with the lower cavity 204. The second water inlet 201 and the outlet of the first passage 3 are located in the lower cavity 204. The second water outlet 202 is located in the upper cavity 203. The second impeller 702 separates the upper cavity 203 and the lower cavity 204, requiring most of the fluid in the lower cavity 204 to enter the upper cavity 203 through the second impeller 702. Thus, most of the fluid is delivered through the second impeller 702, ensuring the output pressure and flow rate of the fluid, while the fluid path remains singular for more stable flow.

To reduce volume, the first cavity 1 and the second cavity 2 are coaxial. The first cavity 1 and the second cavity 2 are arranged vertically, reducing overall volume.

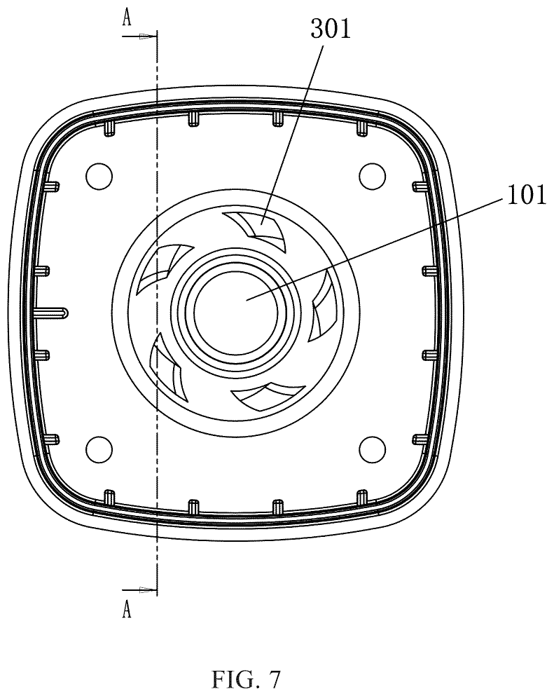

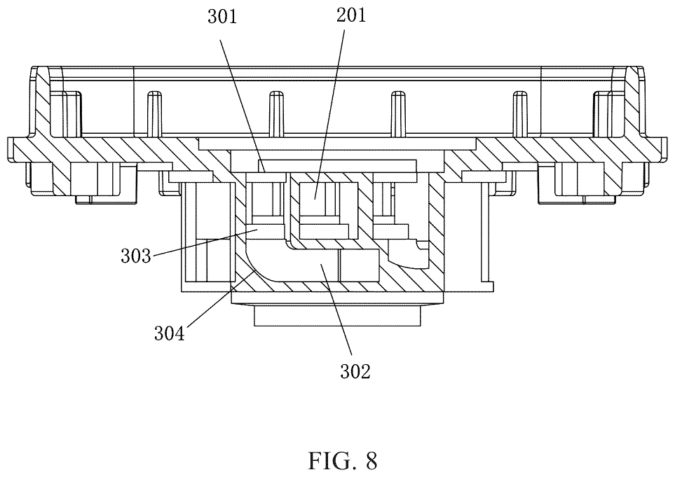

To ensure reliability of the first passage 3, as shown in FIGS. 7 and 8, the first passage 3 includes horizontal passage 302 and rising passage 303. The horizontal passage 302 includes one end communicating with the first cavity 1 and the other end communicating with one end of the rising passage 303. The other end of the rising passage 303 communicates with the second cavity 2. Curved surface 304 is provided between the horizontal passage 302 and the rising passage 303. The curved surface 304 reduces impact when the fluid from the horizontal passage 302 enters the rising passage 303, facilitating smoother delivery. The first water outlet 301 is located in the rising passage 303. Two sides of the horizontal passage 302 in a horizontal direction are curved to reduce impact when the fluid enters the horizontal passage 302, facilitating smoother delivery.

To facilitate rotation of the valve member 4, the valve member 4 is provided with outwardly protruding toggle member 403. The toggle member 403 is configured to drive rotation of the valve member 4. The protruding toggle member 403 is easily operable with a visible operation position. The first housing 5 is provided with first notch 501. The toggle member 403 extends outward through the first notch 501.

### Embodiment 2

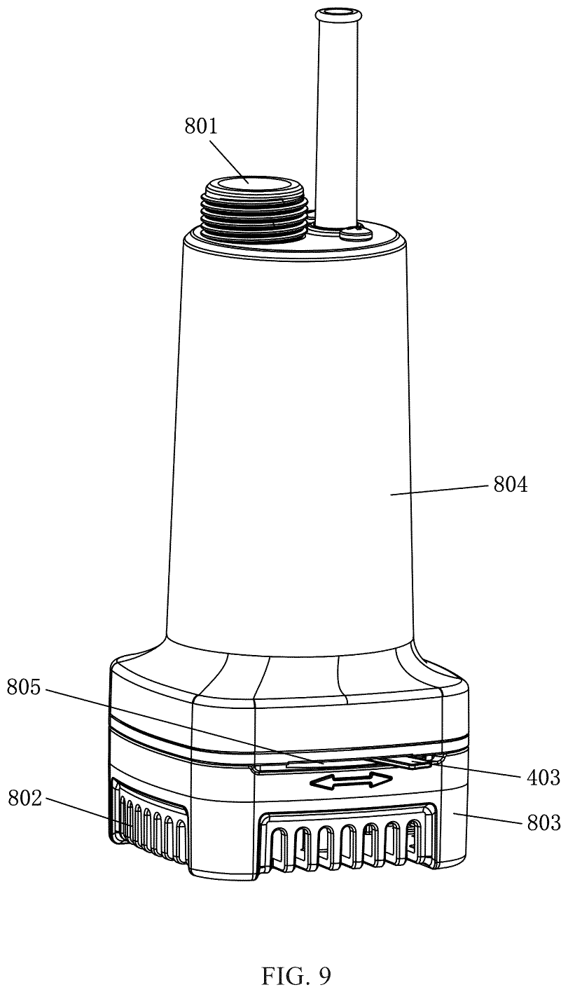

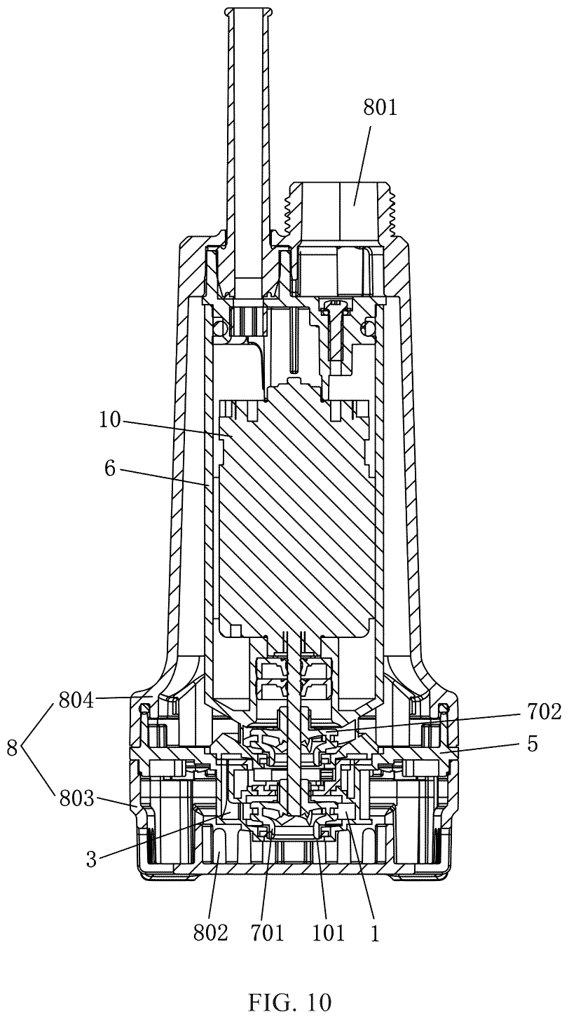

This embodiment provides a fluid pump. As shown in FIGS. 9 and 10, the fluid pump includes the series-parallel fluid switching structure according to Embodiment 1 or Embodiment 4 and first outer housing 8. The first cavity 1 and the second cavity 2 are located in the first outer housing 8. The first outer housing 8 is provided with third water outlet 801 and third water inlet 802. The third water outlet 801 communicates with the first water outlet 301 and the second water outlet 202. The third water inlet 802 communicates with the first water inlet 101 and the second water inlet 201. The first outer housing 8 includes base 803 and upper cover 804. The base 803 and the upper cover 804 are detachably connected. The third water inlet 802 is located on the base 803. The third water outlet 801 is located on the upper cover 804. The first housing 5 and the second housing 6 are disposed in the first outer housing 8. The motor 10 is disposed in the second housing 6. A water inlet cavity is formed between the base 803 and the first housing 5. The water inlet cavity communicates with the first water inlet 101 and the second water inlet 201. A water outlet passage is formed between the upper cover 804 and the second housing 6. Water discharged from the first water outlet 301 and water discharged from the second water outlet 202 reach the third water outlet 801 through the water outlet passage. In this embodiment, the third water inlet 802 is formed by a grating hole and is distributed around the base 803. The third water inlet 802 is a main water inlet on the fluid pump.

To facilitate rotation of the valve member 4, second notch 805 is provided on the base 803 or the upper cover 804 or between the base 803 and the upper cover 804. The toggle member 403 extends outward from the first outer housing 8 through the second notch 805. In this embodiment, the second notch 805 is disposed between the base 803 and the upper cover 804.

### Embodiment 3

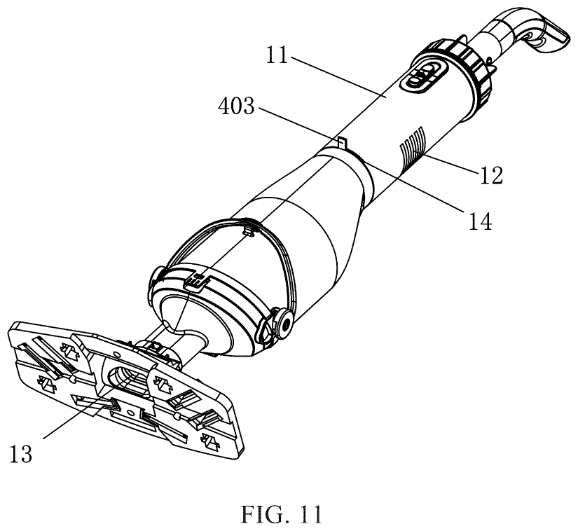

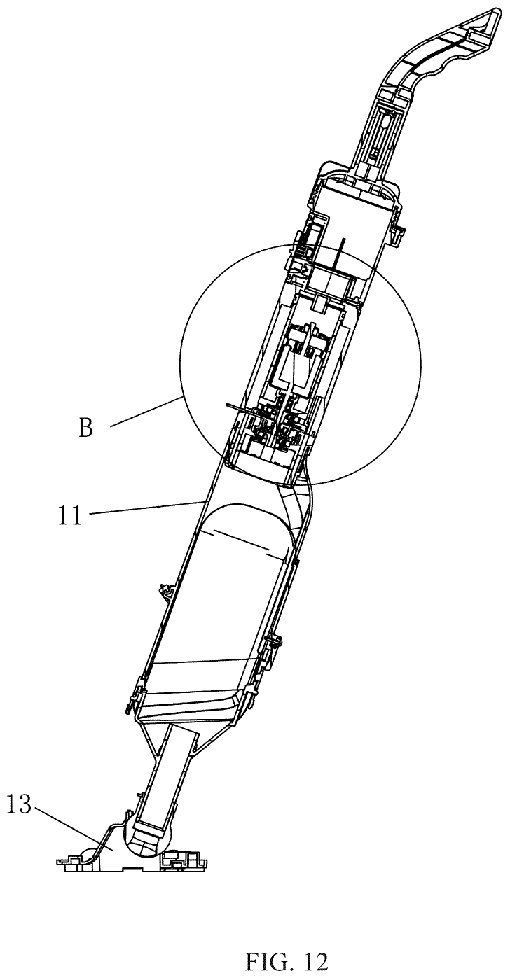

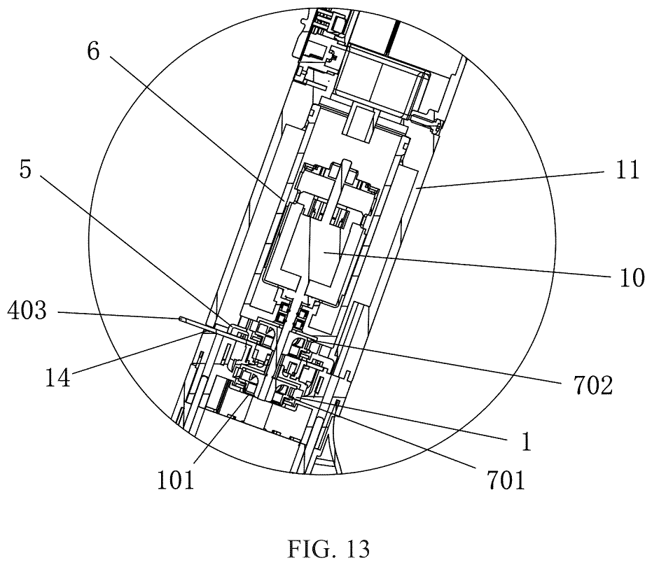

This embodiment provides a pool cleaner. As shown in FIGS. 11, 12, and 13, the pool cleaner includes the series-parallel fluid switching structure according to Embodiment 1 or Embodiment 4 and second outer housing 11. The first cavity 1 and the second cavity 2 are located in the second outer housing 11. The second outer housing 11 is provided with fourth water outlet 12 and fourth water inlet 13. The fourth water outlet 12 communicates with the first water outlet 301 and the second water outlet 202. The fourth water inlet 13 communicates with the first water inlet 101 and the second water inlet 201. In this embodiment, the fourth water inlet 13 is a main water inlet on the pool cleaner. The first housing 5 and the second housing 6 are disposed in the second outer housing 11. The motor 10 is disposed in the second housing 6. A water outlet passage is formed between the second outer housing 11 and the second housing 6. Water discharged from the first water outlet 301 and water discharged from the second water outlet 202 reach the fourth water outlet 12 through the water outlet passage. The fourth water outlet 12 is disposed at an upper end of the second outer housing 11. The fourth water inlet 13 is located at a bottom end of the second outer housing 11. The second outer housing 11 is provided with third notch 14 for the toggle member 403 to extend outward.

### Embodiment 4

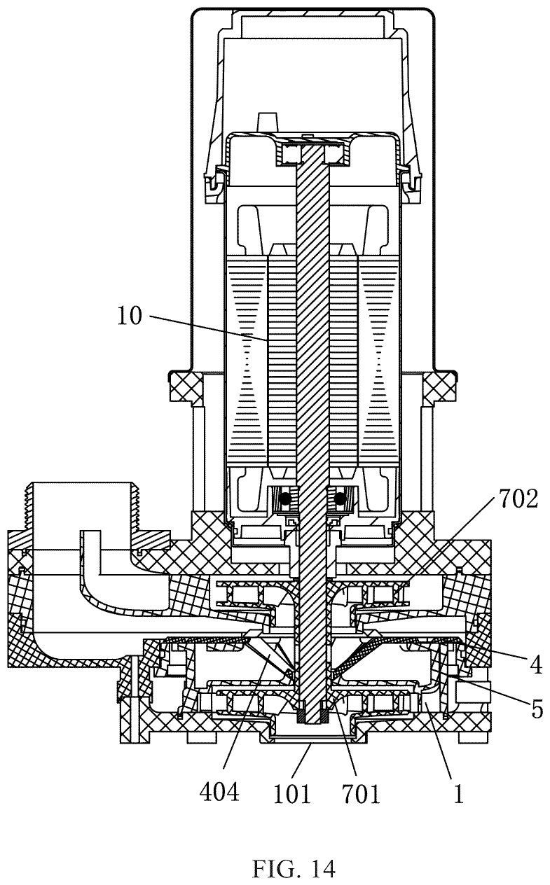

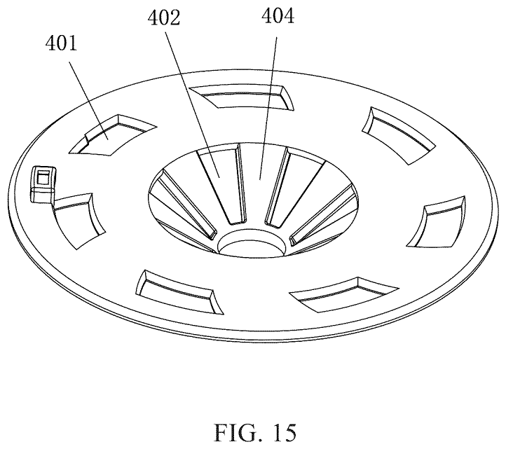

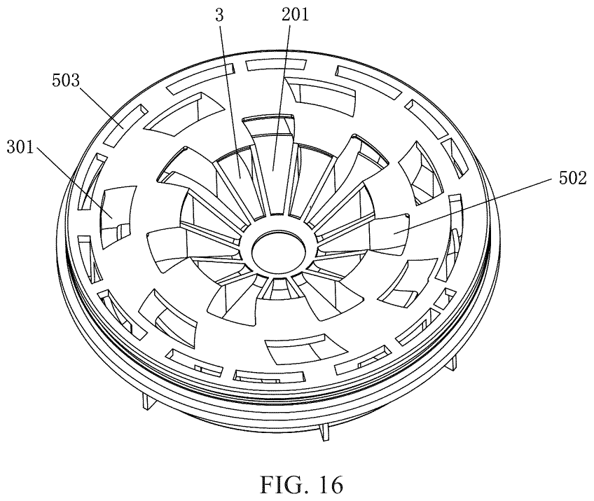

This embodiment provides a series-parallel fluid switching structure. As shown in FIGS. 14 to 16, in addition to the features of Embodiment 1, in this embodiment, there are at least two third passages 402. Oblique blocking plate 404 is provided between adjacent third passages 402. The blocking plate 404 is configured to block the outlet of the first passage 3 or the second water inlet 201. A shape of the outlet of the first passage 3 and a shape of the second water inlet 201 match the blocking plate 404. Specifically, the blocking plate 404 may completely fit the outlet of the first passage 3. That is, a sealing surface is formed to block the outlet of the first passage 3. The blocking plate 404 may also completely fit the second water inlet 201. That is, a sealing surface is formed to block the second water inlet 201. In this embodiment, the blocking plate 404 is provided with an inclined surface. Of course, the blocking plate 404 may be provided with a curved surface.

The design of the blocking plate 404 ensures reliable blocking. The obliquely disposed blocking plate 404 guides the liquid to flow more smoothly, and the inclined surface increases the water outlet area.

To improve the sealing effect, the first housing 5 is provided with first pressure-differential notch 502. The first pressure-differential notch 502 is located at the outlet of the first passage 3. A first pressure-differential engagement zone is formed between the first pressure-differential notch 502 and the valve member 4. The valve member 4 is floatable axially upward and downward. The first housing 5 is provided with second pressure-differential notch 503. The second pressure-differential notch 503 is located at an outer edge of a top surface of the first housing 5. A second pressure-differential engagement zone is formed between the second pressure-differential notch 503 and the valve member 4.

When the fluid pump operates, a positive pressure exists above the valve member 4 and a negative pressure exists below the valve member 4. The valve member 4 is pressed against the first housing 5 by a hydraulic pressure differential to form a seal, preventing foreign matter from entering and jamming the valve member 4. The design of the first pressure-differential notch 502 increases the area for generating the pressure differential on the valve member 4, improving the sealing effect. The first pressure-differential notch 502 is located at an inner side, providing a good sealing effect for the inner side. The design of the second pressure-differential notch 503 increases the area for generating the pressure differential on the valve member 4, improving the sealing effect. The second pressure-differential notch 503 is located at an outer side, providing a good sealing effect for the outer side.

### Embodiment 5

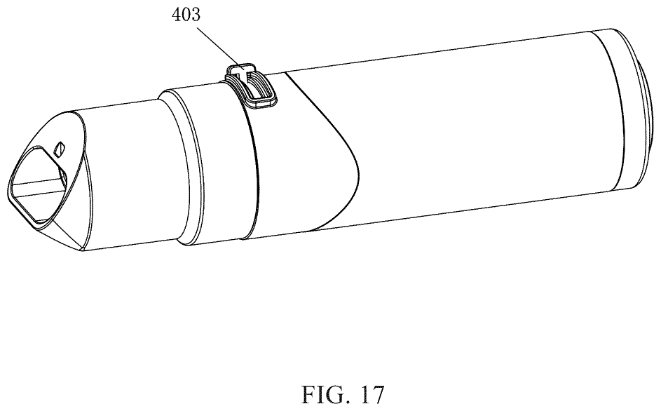

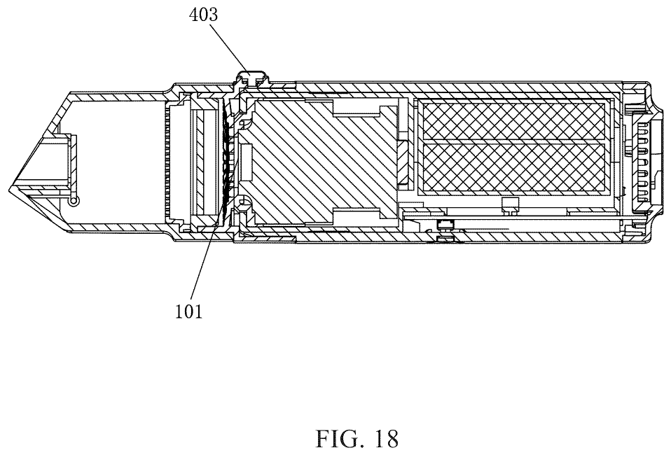

This embodiment provides a handheld suction and blowing device. As shown in FIGS. 17 and 18, the handheld suction and blowing device includes the series-parallel fluid toggle structure according to Embodiment 1 or Embodiment 4.

The above embodiments are only preferred embodiments of the present disclosure, and are not intended to limit the present disclosure in any form. Although the present disclosure is disclosed through the above preferred embodiments, these preferred embodiments are not intended to limit the present disclosure. Any person skilled in the art may make some changes or modifications to the above technical contents without departing from the scope of the technical solution of the present disclosure. However, such changes or modifications should be deemed as equivalent embodiments of the present disclosure. Any simple modification, equivalent change and modification made to the above embodiments according to the technical essence of the present disclosure without departing from the content of the technical solution of the present disclosure should fall within the scope of the technical solution of the present disclosure.

What is claimed is:

1. A series-parallel fluid switching structure, comprising a first cavity, a second cavity, and a switching mechanism, wherein the first cavity is provided with a first water inlet, and the second cavity is provided with a second water inlet; a first passage is disposed between the first cavity and the second cavity; the first passage comprises an inlet communicating with the first cavity and an outlet communicating with the second cavity; the first passage is provided with a first water outlet, and the second cavity is provided with a second water outlet; the switching mechanism is located between the first cavity and the second cavity, and is configured to control opening/closing of the first water outlet, opening/closing of the outlet of the first passage, and opening/closing of the second water inlet; in a parallel state, the first water outlet is open, the outlet of the first passage is closed, and the second water inlet is open; and in a series state, the first water outlet is closed, the outlet of the first passage is open, and the second water inlet is closed.

2. The series-parallel fluid switching structure according to claim 1, wherein the switching mechanism is a valve member; the valve member is provided with a through second passage and a through third passage; in the parallel state, the first water outlet communicates with the through second passage, the outlet of the first passage is blocked by the valve member, and the second water inlet communicates with the through third passage; and in the series state, the first water outlet is blocked by the valve member, the outlet of the first passage communicates with the through third passage, and the second water inlet is blocked by the valve member.

3. The series-parallel fluid switching structure according to claim 2, wherein the valve member is annular, and rotatable relative to the second cavity; the first water outlet is disposed on a rotation path of the through second passage; the second water inlet and the outlet of the first passage are disposed on a rotation path of the through third passage; and the second water inlet and the outlet of the first passage are arranged adjacent to each other in a radial direction.

4. The series-parallel fluid switching structure according to claim 1, further comprising a first housing, wherein the first cavity is disposed in the first housing; a portion of the second cavity is disposed on the first housing; the first cavity is located below the second cavity; the first water inlet is disposed at a lower surface of the first housing; the first passage is disposed in the first housing; the outlet of the first passage is located above the inlet of the first passage; the first water outlet is disposed at an upper surface of the first housing; and the second water inlet is disposed at a side surface of the first housing.

5. The series-parallel fluid switching structure according to claim 4, further comprising a second housing, wherein the second housing is connected to the first housing; the second cavity is disposed between the first housing and the second housing; and the second water outlet is disposed at a side surface of the second housing.

6. The series-parallel fluid switching structure according to claim 1, wherein the first cavity is internally provided with a first impeller; the first impeller comprises a water inlet communicating with the first water inlet and a water outlet communicating with the first cavity; the second cavity is internally provided with a second impeller; and the second impeller comprises a water inlet communicating with the second water inlet and a water outlet communicating with the second cavity.

7. The series-parallel fluid switching structure according to claim 6, wherein the second cavity comprises an upper cavity and a lower cavity; the second impeller is located in the upper cavity; the water inlet of the second impeller communicates with the lower cavity; the second water inlet and the outlet of the first passage are located in the lower cavity; and the second water outlet is located in the upper cavity.

8. The series-parallel fluid switching structure according to claim 1, wherein the first cavity and the second cavity are coaxial.

9. The series-parallel fluid switching structure according to claim 4, wherein the first passage comprises a horizontal passage and a rising passage; the horizontal passage comprises a first end communicating with the first cavity and a second end communicating with a first end of the rising passage; a second end of the rising passage communicates with the second cavity; a curved surface is provided between the horizontal passage and the rising passage; the first water outlet is located in the rising passage; and two sides of the horizontal passage in a horizontal direction are curved.

10. The series-parallel fluid switching structure according to claim 3, wherein the valve member is provided with an outwardly protruding toggle member; and the outwardly protruding toggle member is configured to drive rotation of the valve member.

11. The series-parallel fluid switching structure according to claim 2, wherein there are at least two through third passages; an oblique blocking plate is provided between adjacent through third passages; the oblique blocking plate is configured to block the outlet of the first passage or the second water inlet; and a shape of the outlet of the first passage and a shape of the second water inlet match the oblique blocking plate.

12. The series-parallel fluid switching structure according to claim 4, wherein the first housing is provided with a first pressure-differential notch and/or a second pressure-differential notch; the first pressure-differential notch is located at the outlet of the first passage; a first pressure-differential engagement zone is formed between the first pressure-differential notch and the switching mechanism; the second pressure-differential notch is located at an outer edge of a top surface of the first housing; and a second pressure-differential engagement zone is formed between the second pressure-differential notch and the switching mechanism.

13. A fluid pump, comprising the series-parallel fluid switching structure according to claim 1 and a first outer housing, wherein the first cavity and the second cavity are located in the first outer housing; the first outer housing is provided with a third water outlet and a third water inlet; the third water outlet communicates with the first water outlet and the second water outlet; and the third water inlet communicates with the first water inlet and the second water inlet.

14. The fluid pump according to claim 13, wherein the first outer housing comprises a base and an upper cover; the base and the upper cover are detachably connected; the third water inlet is located on the base; and the third water outlet is located on the upper cover.

15. A pool cleaner, comprising the series-parallel fluid switching structure according to claim 1 and a second outer housing, wherein the first cavity and the second cavity are located in the second outer housing; the second outer housing is provided with a fourth water outlet and a fourth water inlet; the fourth water outlet communicates with the first water outlet and the second water outlet; and the fourth water inlet communicates with the first water inlet and the second water inlet.

16. The fluid pump according to claim 13, wherein in the series-parallel fluid switching structure, the switching mechanism is a valve member; the valve member is provided with a through second passage and a through third passage; in the parallel state, the first water outlet communicates with the through second passage, the outlet of the first passage is blocked by the valve member, and the second water inlet communicates with the through third passage; and in the series state, the first water outlet is blocked by the valve member, the outlet of the first passage communicates with the through third passage, and the second water inlet is blocked by the valve member.

17. The fluid pump according to claim 16, wherein in the series-parallel fluid switching structure, the valve member is annular, and rotatable relative to the second cavity; the first water outlet is disposed on a rotation path of the through second passage; the second water inlet and the outlet of the first passage are disposed on a rotation path of the through third passage; and the second water inlet and the outlet of the first passage are arranged adjacent to each other in a radial direction.

18. The fluid pump according to claim 13, wherein the series-parallel fluid switching structure further comprises a first housing, wherein the first cavity is disposed in the first housing; a portion of the second cavity is disposed on the first housing; the first cavity is located below the second cavity; the first water inlet is disposed at a lower surface of the first housing; the first passage is disposed in the first housing; the outlet of the first passage is located above the inlet of the first passage; the first water outlet is disposed at an upper surface of the first housing; and the second water inlet is disposed at a side surface of the first housing.

19. The fluid pump according to claim 18, wherein the series-parallel fluid switching structure further comprises a second housing, wherein the second housing is connected to the first housing; the second cavity is disposed between the first housing and the second housing; and the second water outlet is disposed at a side surface of the second housing.

20. The fluid pump according to claim 13, wherein in the series-parallel fluid switching structure, the first cavity is internally provided with a first impeller; the first impeller comprises a water inlet communicating with the first water inlet and a water outlet communicating with the first cavity; the second cavity is internally provided with a second impeller; and the second impeller comprises a water inlet communicating with the second water inlet and a water outlet communicating with the second cavity.
